(19) United States
(12) Patent Application Publication
(10) Pub. No.: US 2024/0261811 A1
(43) Pub. Date: Aug. 8, 2024

(54) Sprinkler Informational Tag

(71) Applicant: Rain Bird Corporation, Azusa, CA (US)

(72) Inventors: Suzanne Marie Schneider, Corona de Tucson, AZ (US); Jeffrey Glenn Johnson, Oro Valley, AZ (US)

(21) Appl. No.: 18/164,449

(22) Filed: Feb. 3, 2023

(51) Int. Cl. B05B 15/00; B05B 15/625

(52) U.S. Cl. CPC B05B 15/00; B05B 15/625; G09F 23/00

(57) ABSTRACT

A sprinkler informational plug is provided. The plug includes a cap, a shaft, and a key. The cap includes a plurality of grips disposed about peripheral surface of the cap. The shaft is tapered between the cap and the key. The key includes a first bit and a second bit extending from the key. The plug is configured to be inserted through a cover and to engage a lock plate of the sprinkler to secure the plug to the sprinkler.

### FIELD

This application generally relates to providing changeable information on sprinklers and, more particularly, to indicator tags that are removably attached to sprinklers.

### BACKGROUND

Irrigation devices, such as sprinklers, are used in irrigation systems. Sprinklers discharge water to surrounding vegetation. There is a need to provide custom information on sprinklers. For example, many sprinklers discharge potable water. However, non-potable water is also used with sprinklers. Sources of non-potable water include reclaimed rainwater runoff or grey water from building systems.

Irrigation devices discharging non-potable water tend to be marked with some identifier that typically includes purple, which is generally known as an indicator for non-potable water. For many irrigation devices, this generally means that there is separate version of the device marked with purple. To avoid multiple versions of the same device, there is a need to easily customize the irrigation devices with the color purpose when discharging non-potable water. The same type of customization also could be used to provide other relevant information regarding the irrigation device, such as location or zone, or advertising.

### BRIEF DESCRIPTION OF THE DRAWINGS

FIG. 1 is a perspective view of an irrigation sprinkler and associated informational plug according to one aspect of the present disclosure;

FIG. 2 is a perspective view of the water informational plug installed to the irrigation sprinkler illustrated of FIG. 1;

FIG. 3 is a perspective view of the informational plug of FIG. 1;

FIG. 4 is another perspective view the informational plug of FIG. 1;

FIG. 5 is a cross-section view of the sprinkler and installed informational plug taken along line 5-5 of FIG. 2;

FIG. 6 is a close-up view of a portion of the cross-section of FIG. 5 including the informational plug;

FIG. 7 is a plan view of the informational plug and the water sprinkler of FIG. 1 with a cover of the sprinkler removed;

FIG. 8 is a plan view of the informational plug and the water sprinkler of FIG. 1 with the cover removed from the sprinkler and separated into its elastomeric portion and support plate;

FIG. 9 is a plan view of the informational plug and the water sprinkler of FIG. 1 with the cover and a lock plate removed from the sprinkler and the cover separated into its elastomeric portion and support plate;

FIG. 10 is a bottom view of the informational plug and the water sprinkler of FIG. 1 with the cover and a lock plate removed from the sprinkler and the cover separated into its elastomeric portion and support plate;

FIG. 11 is a bottom view of the informational plug installed into the sprinkler of FIG. 1; and

FIG. 12 is a cross-section view taking along line 12-12 of FIG. 2.

### DETAILED DESCRIPTION

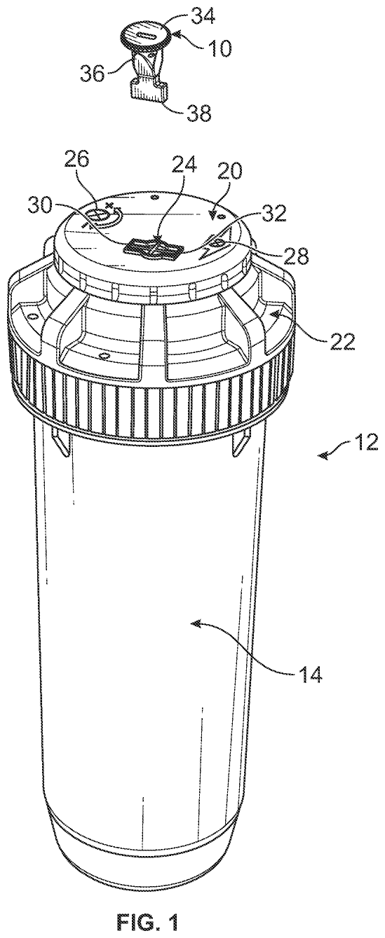

FIG. 1 illustrates one embodiment of an indicator such as informational plug 10 for use with an irrigation sprinkler 12. The informational plug 10 can indicate the type of water being discharged from each sprinkler in the irrigation system. More specifically, the informational plug 10 may include purple coloring to indicate that non-potable water is being emitted by the sprinkler 12. As another example, the informational plug 10 may include tan coloring to indicate that water is emitted at high speeds, for example, for dust suppression. As another example, the informational plug 10 may include green coloring to indicate that water discharge from the rotor of the sprinkler is capable of being shut off at the rotor. The informational plug 10 may also provide identification information for the location, type, or other information about the sprinkler 12. The informational plug 10 could be used to display advertising. Overall, the informational plug 10 has a wide range of applications.

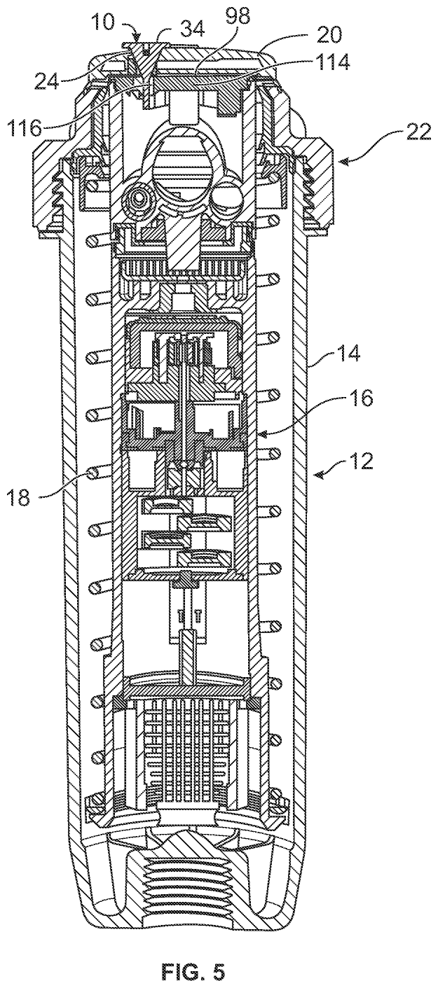

As explained further herein, the informational plug 10 is designed to be easily attached to a top of the sprinkler 12. For instance, the informational plug 10 maybe designed as key that locks into a keyway on the top of the sprinkler 10. Further, the keyway may be multi-functional. For example, and with reference to FIG. 5, the sprinkler 12 is a pop-up sprinkler that includes a stationary housing 14 and a riser 16 that reciprocates in and out of the housing 14. More specifically, a spring 18 retracts the riser 16 into the housing 14 between irrigation cycles and water pressure forces the riser 16 from the housing 14 against the bias of the spring 18 during irrigation cycles. A tool may be used with the keyway to aid in pulling the riser 16 from the housing 14 to service the riser 16.

The water sprinkler 12 includes a riser cover 20 and a housing cap 22. The riser cover 20 engages the housing cap 22 when the riser 16 is retracted into the housing 14. The riser cover 20 defines three access ports 24, 26, 28. The first port 24 provides access to a pull-up feature that allows a user to insert a tool to manually pull the riser 16 from the housing 14. The first port 24 includes a first keyway 30 and a second keyway 32. In the illustrated configuration, the first keyway 30 and the second keyway 32 radially extend from opposing sides of the first port 24. As discussed in further detail below, the informational plug 10 maybe inserted into the port 24 and coupled to the sprinkler 12.

The other two ports 26, 28 allow a user access to adjustment features of the sprinkler 12. In one configuration, the access port 26 provides access to an adjustment feature of the sprinkler 12 to change the arc of irrigation. The access port 28 provides access to an adjustment feature of the sprinkler 12 to change the radius of irrigation coverage.

Although the informational plug 10 is shown and described herein in use with water sprinkler 12 by way of example, the informational plug 10 may similarly be used with other types of water sprinkler and any piece of irrigation equipment generally known in the art. For example, the informational plug 10 maybe used with a valve or valve housing to indicate that the irrigation system uses non-potable water.

Regarding the informational plug 10, the informational plug 10 includes a flange portion such as top cap 34, a shaft 36, and a key 38. The informational plug 10 is configured to be inserted into the access port 24 when the key 38 is aligned with the first keyway 30 and the second keyway 32. The informational plug 10 maybe made from any material generally known in the art, such as, a plastic material. As one example, the informational plug 10 is molded from a plastic material as a single piece. The informational plug 10 can be made in different colors to indicate certain information. For example, the informational plug 10 maybe made in or include a purple color to indicate that the sprinkler 12 is using non-potable water.

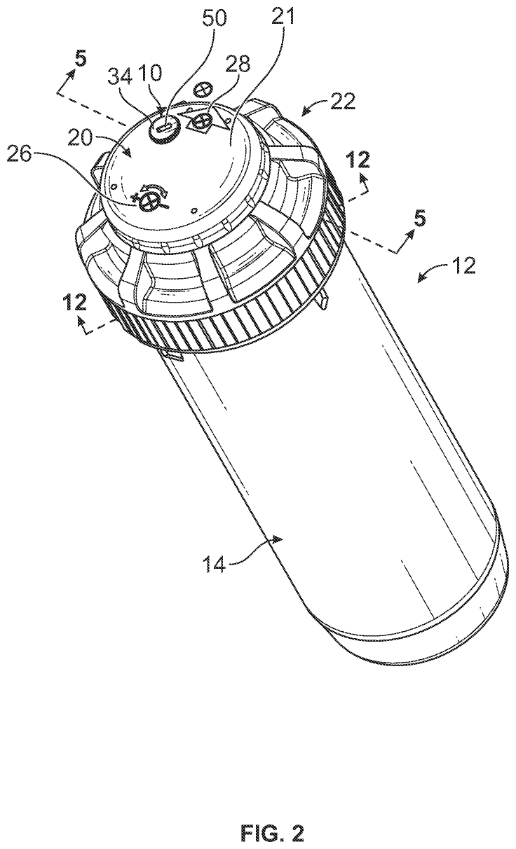

With reference to FIGS. 2 and 5, the informational plug 10 is shown fully inserted into the port 24 of the sprinkler 12. When the informational plug 10 is fully installed on the sprinkler 12, the cap 34 of the informational plug 10 may cover the first port 24. The cap 34 of the informational plug 10 may sit flush against a first side 21 of the cover 20 which may aid to inhibit debris from entering into the port 24 when the informational plug 10 is inserted into the port 24.

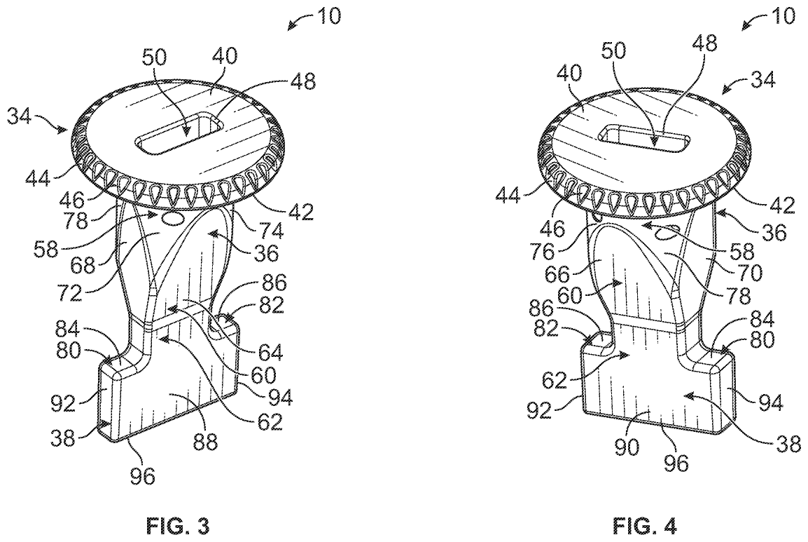

Turning to FIGS. 3 and 4, the cap 34 of the informational plug 10 has a top surface 40, a bottom surface 42, and a perimeter surface 44 extending from the top surface 40 to the bottom surface 42. The perimeter surface 44 may include grip elements 46, such as projections and/or dimples, extending around the circumference of the cap 34. The grip elements 46 may enhance a user's grip of the cap 34 when inserting or removing the informational plug 10 from the sprinkler 12. In some embodiments, the top surface 40 of the informational plug 10 may 10 may include markings and/or text providing identifying information of the sprinkler 12. For instance, the identifying information may include an identification of the sprinkler, location of the sprinkler, water type (e.g., non-potable water), advertising, and/or logos.

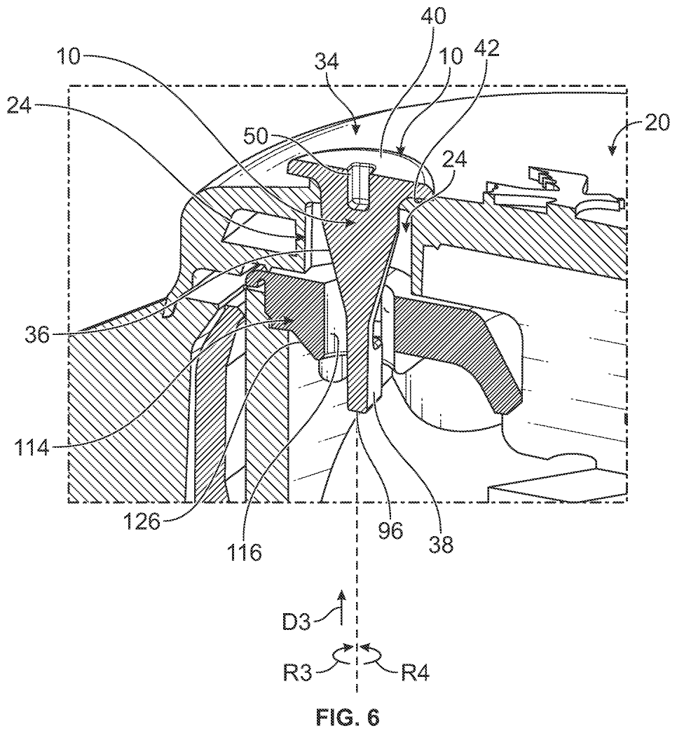

The top surface 40 also defines an opening 48 that extends through the cap 34 and into the shaft 36 of the informational plug 10 to define a socket 50. The socket 50 may be sized and shaped to receive an end portion of a drive tool (e.g., a screwdriver). In the form shown, the socket 50 is configured to receive the head of a flathead screwdriver. In other forms, the socket 50 may be configured to receive other types of drive heads, for example, Phillips or torx. The end portion of the drive tool may be inserted into the socket 50 to rotate the informational plug 10 about the axis A in directions R3 and R4 (see FIG. 6) to couple and uncouple the informational plug 10 to the sprinkler 12 as discussed below.

Returning to FIGS. 3 and 4, the shaft 36 of the informational plug 10 extends from the bottom surface 42 of the cap 34. The shaft 36 has an upper section 58, a tapered section 60, and a neck section 62. The upper section 58 is substantially cylindrical and extends from the cap 34 toward the tapered section 60. The tapered section 60 includes a first side 64, a second side 66, a third side 68, and a fourth side 70 that taper inward as they extend from the cylindrical upper section 58 to the neck section 62. The first side 64 and the second side 66 of the tapered section 60 are located on opposing sides of the shaft 36 and taper towards one another as they extend toward the neck section 62. Similarly, the third side 68 and the fourth side 70 are located on opposing sides of the shaft 36 and taper towards one another as they extend towards the neck section 62. The tapered sides 64, 66, 68, 70 may taper at a constant angle such that they are substantially flat.

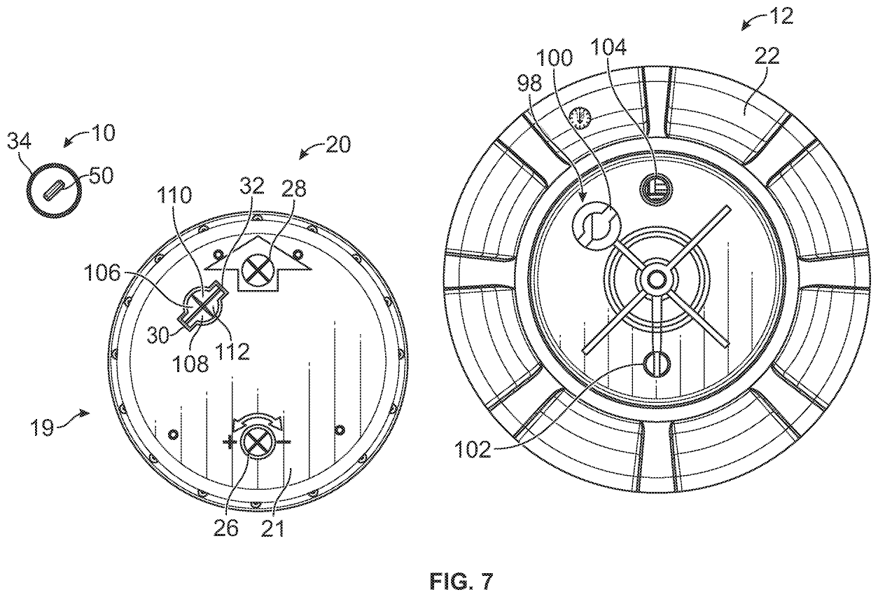

The upper section 58 includes a first portion 72, a second portion 74, a third portion 76, and a fourth portion 78 that extend longitudinally between adjacent ones of the tapered sides 64, 66, 68, 70. The first portion 72 is positioned diametrically opposite the third portion 76, and the second portion 74 is positioned diametrically opposite the fourth side 78. The riser cover 20 includes flaps 106, 108, 110, 112 covering the port 24 (see FIG. 7). The flaps 106, 108, 110, 112 may be elastically deflectable and close the port 24 when the informational plug 10 is not inserted therein (see FIG. 1). For example, the riser cover 20 and/or the flaps 106, 108, 110, 112 may be formed of an elastomeric material, for example, silicone and/or rubber. The flaps thus aid to inhibit debris from entering the port 24 when the informational plug 10 is not inserted therein. Insertion of the informational plug 10 into the port 24 brings the tapered sides 64, 66, 68, 70 into contact with the flaps which deflects the flaps to open the port 24. The flaps 106, 108, 110, 112 engage the upper section 150 of the informational plug 10 when the informational plug 10 is inserted into the port 24 which may aid to inhibit debris from entering the port 24 when the informational plug 10 is inserted therein. Moreover, the cylindrical upper section 150 proves a smooth surface that the flaps 106, 108, 110, 112 engage which the permits the informational plug 10 to be rotated once inserted in the port 24 as discussed below.

The first side 64 and the second side 66 extend from the tapered section 60 to the neck section 62. At the neck 62, first side 64 and the second side 66 extend generally parallel to another and generally perpendicular to the third side 68 and the fourth side 70, forming a generally rectangular cross-section.

The neck 62 extends to the key 38. The key 38 includes a first bit 80 and a second bit 82. The first bit 80 and second bit 82 extend radially outward from the neck 62 in opposing directions such that the neck 62 and the key 38 together have a T-shape. An upper surface 84 of the first bit 80 and an upper surface 86 of the second bit 82 are configured to engage a lower surface 126 of a locking plate 114 when installed in the sprinkler 12 to inhibit the informational plug 10 from being unintentionally removed once installed. The key 38 includes a first side surface 88 that is extends generally parallel with an opposing second side surface 90. The key 38 further includes a third side surface 92 that extends generally parallel with an opposing a fourth surface 94. The first and second side surfaces 88, 90 may be generally perpendicular to the third and fourth side surfaces 92, 94. The key 38 may also include an end surface 96 that forms the bottom or terminal end of the key 38.

With reference to FIG. 7, the informational plug 10 and an elastomeric layer 19 of the riser cover 20 are removed from the water sprinkler 12 exposing a plate 98 of the riser cover 20 located at the upstream end of the water sprinkler 12. The plate 98 may be a rigid plate formed of a plastic that forms the support structure of the riser cover 20. For example, the elastomeric layer 19 is overmolded on to the plate 98. The plate 98 has a first opening 100, a second opening 102, and a third opening 104 that correspond respectively with the ports 24, 26, 28 of riser cover 20.

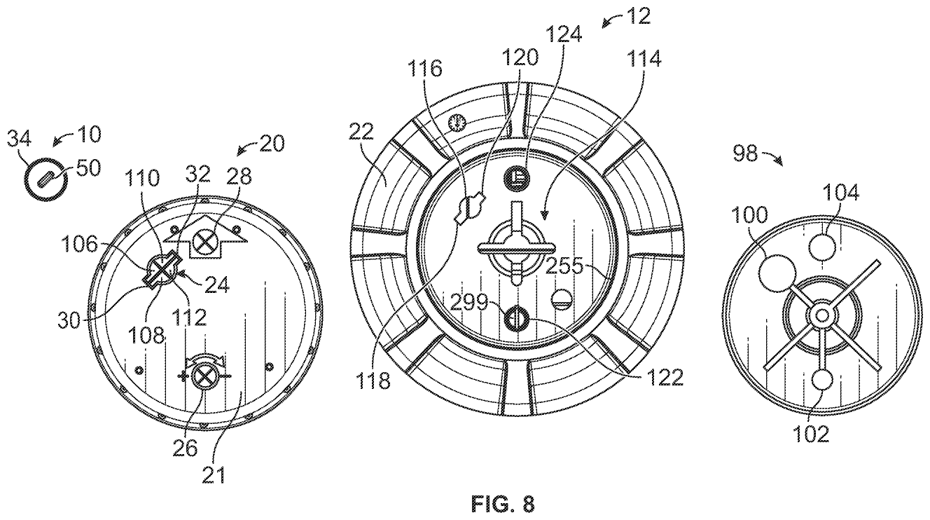

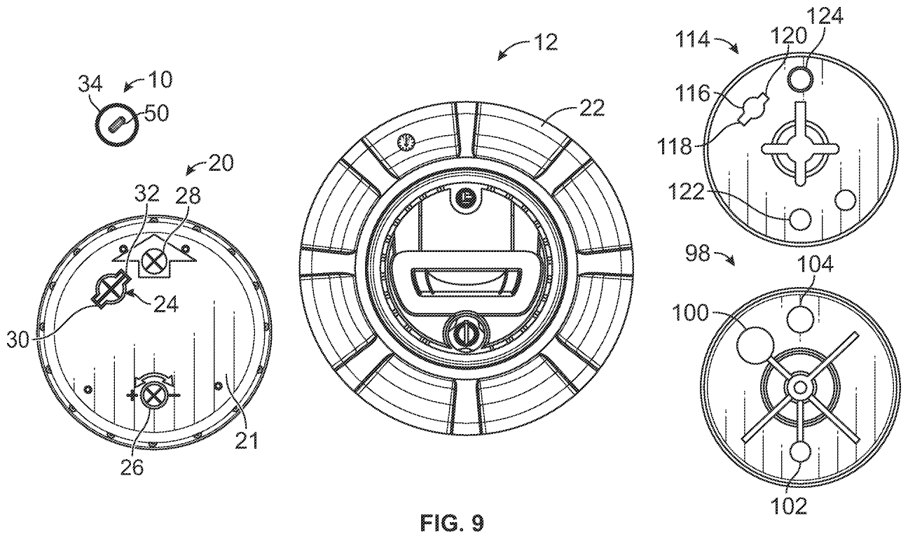

With reference to FIG. 8, the informational plug 10, the riser cover 20, and the plate 98 are shown removed from the remainder of the water sprinkler 12 to show a lock plate 114 to which the informational plug 10 couples. With reference to FIG. 9, the lock plate 114 is further removed from the remainder of the water sprinkler 12. The lock plate 114 includes a keyhole opening 116 including a first keyway 118 and a second keyway 120. The key 38 of the informational plug 10 is sized and shaped so that the key 38 passes through the keyhole opening 116 of the lock plate 114 when properly aligned with the keyhole opening 116. More specifically, the first bit 80 and the second bit 82 of the key 38 are sized and shaped to pass through the respective first keyway 118 and the second keyway 120 of the lock plate 114.

The lock plate 114 has a second opening 122 that corresponds to and aligns with the second opening 102 in the plate 98 and the second port 26 in the cover 20 to permit access to the arc adjustment of the sprinkler 12. The lock plate 114 has a third opening 124 that corresponds to and aligns with the third opening 104 in the plate 98 and the third slot 28 in the cover 20 to provide access to the radius adjustment.

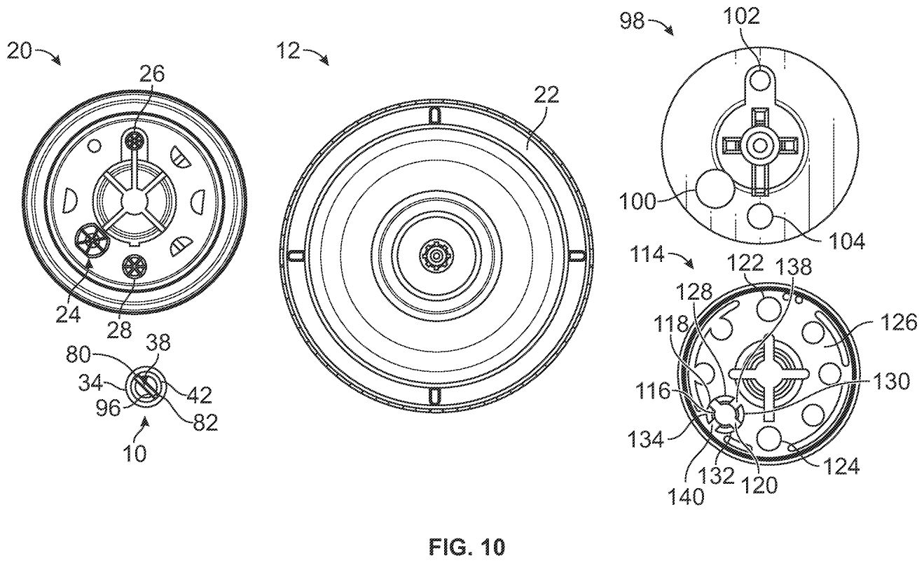

With reference to FIGS. 10, 11, and 12, a lower surface 126 of the lock plate 114 is shown including a first projection 128, a second projection 130, a third projection 132, and a fourth projection 134. The projections 128, 130, 132, 134 are positioned around the circumference of the keyhole opening 116 that extends through the lock plate 114. The projections 128, 130, 132, 134 may each be partially annular projections.

The first keyway 118 extends between the first projection 128 and the fourth projection 134, and the second keyway 120 extends between the second projection 130 and third projection 132. The lock plate 114 includes a locking recess such as a first keyseat 138 between the first projection 128 and the second projection 130. The first keyseat 138 may be a recess or groove extending between the first and second projections 128, 130. The lock plate 114 further includes a locking recess such as a second keyseat 140 between the third projection 132 and the fourth projection 134. The second keyseat 140 may be a recess or groove extending between the third and fourth projections 132, 134.

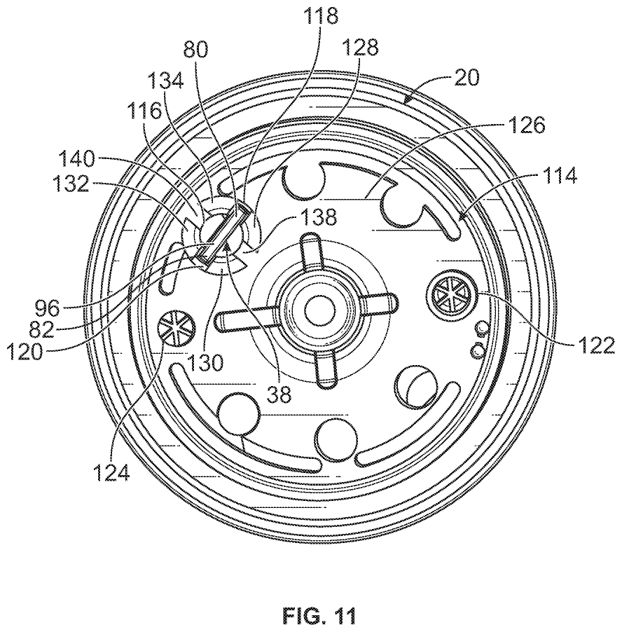

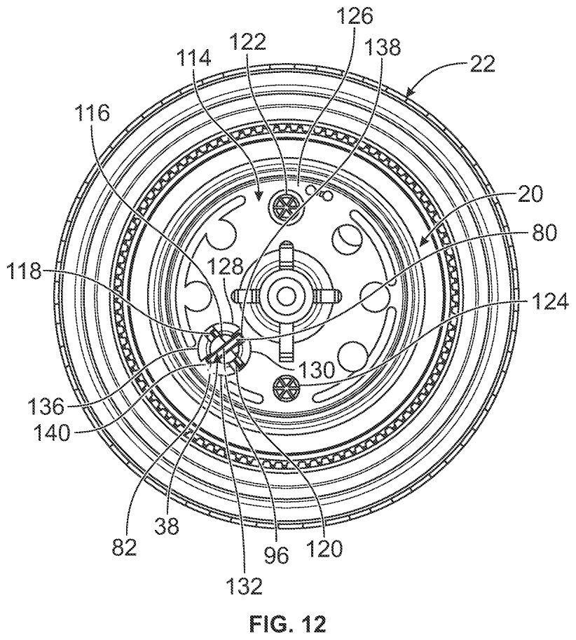

With reference to FIG. 11, the informational plug 10 is inserted into the keyhole opening 116 of the lock plate 114 with the first bit 80 of the key 38 aligned with the first keyway 118 of the lock plate 114 and the second bit 82 of the key 38 aligned within the second keyway 120 of the lock plate 114. Force may be applied to the informational plug 10 (e.g., by a screwdriver inserted into the socket 50) to rotate the first and second bits 80, 82 to the first and second keyseats 138, 140 to couple the informational plug 10 to the sprinkler 12. For example, the informational plug 10 maybe rotated in a clockwise manner such that the first bit 80 cams or slides over the first projection 128 and enters into the first keyseat 138 of the lock plate 114 and the second bit 82 cams or slides over the third projection 132 and enters the second keyseat 140 (see FIG. 12). As the first and second bits 80, 82 pass over the projections, the cap 34 of the informational plug 10 may compress the elastomeric riser cover 20. When the bits 80, 82 enter the keyseats 138, 140, the elastomeric riser cover 20 may decompress and apply an upward force on the cap 34 of the informational plug biasing the bits 80, 82 into the keyseats 138, 140. Alternatively, the informational plug 10 maybe rotated in a counterclockwise manner such that first bit 80 cams or slides over the fourth projection 134 and enters the second keyseat 140 and the second bit 82 cams or slides over the second projection 130 to enter the first keyseat 138.

With reference to FIG. 12, the informational plug 10 is shown coupled to the sprinkler 12 with the first bit 80 in the first keyseat 138 and the second bit 82 in the second keyseat 140. The upper surfaces 84, 86 of the first and second bits 80, 82 contact and hook the lower surface 126 of the lock plate 114 inhibiting the informational plug 10 from being drawn upward and out of the port 24. Moreover, the first and second bits 80, 82 are not able to pass over the projections to the keyways 118, 120 without axial and rotational force being applied to the informational plug 10 and thus the informational plug 10 is coupled to the sprinkler 12. Coupling the informational plug 10 to the lock plate 114 inhibits the unintentional or inadvertent removal of the informational plug 10 from the water sprinkler 12.

The informational plug 10 may also couple the riser cover 20 and/or plate 98 to the lock plate 114 of the sprinkler 12 when the informational plug 10 is coupled to the lock plate 114 as described above. Thus, the informational plug 10 can also prevent the unintentional or inadvertent removal of the riser cover 20 and/or plate 98 from the rest of the water sprinkler 12.

The informational plug 10 maybe uncoupled from the water sprinkler 12 by pushing the informational plug 10 axially and rotating the informational plug 10 in either a clockwise (R3) or counterclockwise (R4) direction (see FIG. 6) until the first and second bit 80, 82 of the key 38 are aligned with the keyways 118, 120 of the lock plate 114. Once the bits 80, 82 are aligned with the keyways 118, 120, the informational plug 10 is able to be withdrawn from the sprinkler 12 through the lock plate 114 and cover 20, for example, by pulling the informational plug 10 in direction D3 (FIG. 6).

The matter set forth in the foregoing description and accompanying drawings is offered by way of example and illustration only and not as a limitation. While certain embodiments have been shown and described, it will be apparent to those skilled in the art that additions, changes, and modifications may be made without departing from the broader aspects of the technological contribution. The actual scope of the protection sought is intended to be defined in the following claims.

What is claimed is:

1. A sprinkler indicator comprising:
a flange portion having a first surface and a second surface opposite the first surface;
a driver located at least in part at the flange portion to move the sprinkler indicator;
a shaft extending from the second surface of the flange portion; and
a key supported by the shaft and including at least a first bit extending radially outward from the shaft.

2. The sprinkler indicator of claim 1 wherein the first surface includes identifying information.

3. The sprinkler indicator of claim 2 wherein the identifying information includes coloring coordinated with a predetermined use or feature of a sprinkler.

4. The sprinkler indicator of claim 1 wherein the shaft includes a tapered portion tapering inwardly as the shaft extends from the flange portion toward the key.

5. The sprinkler indicator of claim 1 wherein the flange portion includes a perimeter extending between the first surface and second surface of the flange portion, and the perimeter includes an inconsistent profile for gripping.

6. The sprinkler indicator of claim 5 wherein the inconsistent profile includes protrusions and/or recesses.

7. The sprinkler indicator of claim 1 wherein the driver defines a socket shaped to receive a complementary drive portion of a tool.

8. The sprinkler indicator of claim 7 wherein the socket defines an elongated opening.

9. The sprinkler indicator of claim 1 wherein the key includes a second bit, and the first bit and the second bit extend radially outward from the shaft in opposing directions.

10. The sprinkler indicator of claim 1 wherein the first surface includes advertising information.

11. An irrigation device with an indicator comprising:
a sprinkler including a cover and a locking plate, the cover defining an access port, the locking plate defining a first keyway aligned with the access port; and
an indicator removably coupled to the sprinkler, the indicator including:
a flange portion having a first surface and a second surface opposite the first surface;
a shaft extending from the second surface;
a key supported by the shaft and including a first bit extending radially outward from the shaft,
wherein the first bit of the key is shaped for insertion through the access port of the cover and the first keyway of the locking plate, the indicator rotatable relative to the locking plate to misalign the first bit and the first keyway to couple the indicator to the sprinkler.

12. The irrigation device of claim 11 wherein the locking plate includes a locking recess, and the first bit being shaped to be received in the locking recess when the first bit is misaligned with the first keyway.

13. The irrigation device of claim 12 wherein the locking plate includes at least one locking protrusion, and rotation of the indicator causes the first bit to slide over one of the at least one locking protrusion into the locking recess.

14. The irrigation device of claim 11 wherein the locking plate includes a second keyway, the key includes a second bit extending radially outward from the shaft and opposite the first bit, the second bit of the key is shaped to be inserted through the access port of the cover and the second keyway of the locking plate, and the plug rotatable relative to the locking plate to misalign the second bit and the second keyway to couple the indicator to the water sprinkler.

15. The irrigation device of claim 11 wherein the sprinkler includes a housing and a riser movable relative to the housing, and the riser includes the cover and the locking plate.

16. The irrigation device of claim 11 wherein the first surface of the flange portion bears identifying information for the sprinkler.

17. The irrigation device of claim 11 wherein the shaft of the indicator tapers inward as the shaft extends from the flange portion toward the key.

18. The irrigation device of claim 11 wherein at least the flange portion defines a socket.

19. The irrigation device of claim 18 wherein the socket is shaped to receive a driver portion of a tool.

20. The irrigation device of claim 11 wherein the cover includes at least one deflectable flaps at the access port.

21. A method of installing an indicator to an irrigation device, the method comprising:
aligning a key of an indicator with an access port of a cover of a sprinkler;
inserting the key into the access port until a first bit of the key extends through a first keyway of a lock plate; and
rotating the indicator until the first bit is misaligned with the first keyway.

22. The method of claim 21 wherein rotating the indicator includes rotating the indicator until the first bit is received in a keyseat of the lock plate.

23. The method of claim 22 wherein rotating the indicator includes rotating the indicator to slide the first bit over a locking protrusion to the keyseat.

24. The method of claim 21 further comprising inserting a driver portion of a tool into a socket of the indicator, wherein rotating the indicator includes rotating the indicator with the tool.
